(19) United States
(12) Patent Application Publication
(10) Pub. No.: US 2012/0127101 A1
(43) Pub. Date: May 24, 2012

(54) DISPLAY CONTROL APPARATUS

(75) Inventor: Yuji Kawahara, Osaka-fu (JP)

(73) Assignee: SANYO ELECTRIC CO., LTD., Moriguchi-shi (JP)

(21) Appl. No.: 13/297,808

(22) Filed: Nov. 16, 2011

(30) Foreign Application Priority Data
Nov. 19, 2010 (JP) 2010-258735

(51) Int. Cl. G06F 3/041

(52) U.S. Cl. 345/173

(57) ABSTRACT

A display control apparatus includes a first displayer. A first displayer displays a first image on a screen. A second displayer displays a second image on the screen. A determiner repeatedly determines whether or not an object exists near the screen. A controller displays the second image when it is determined by the determiner that the object exists near the screen, and hides the second image when it is determined by the determiner that the object does not exist near the screen. An acceptor accepts a touch operation to the screen in association with displaying the second image. A processor performs a process different depending on a manner of the touch operation accepted by the acceptor.

### CROSS REFERENCE OF RELATED APPLICATION

The disclosure of Japanese Patent Application No. 2010-258735, which was filed on Nov. 19, 2010, is incorporated here by reference.

### BACKGROUND OF THE INVENTION

1. Field of the Invention

The present invention relates to a display control apparatus. More particularly, the present invention relates to a display control apparatus which controls an image display so as to be different depending on a position of an object.

2. Description of the Related Art

According to one example of this type of apparatus, it is determined by an infrared reflection sensor whether or not a visitor for the pastimes exists in front of a toilet bowl installed at a rest room. When the visitor does not exist in front of the toilet bowl, a televising screen of a general TV is broadcasted in a silent state. When the visitor stands in front of the toilet bowl, the televising screen is interrupted, and an image and a sound equivalent to advertising information are outputted. Thereby, it becomes possible to efficiently convey the information to the visitor.

However, in the above-described apparatus, an icon is not displayed on the screen for a touch operation, and a behavior is not changed by touching the screen. In such a respect, in the above-described apparatus, a behavior performance is limited.

### SUMMARY OF THE INVENTION

A display control apparatus according to the present invention, comprises: a first displayer which displays a first image on a screen; a second displayer which displays a second image on the screen; a determiner which repeatedly determines whether or not an object exists near the screen; a controller which displays the second image when it is determined by the determiner that the object exists near the screen, and hides the second image when it is determined by the determiner that the object does not exist near the screen; an acceptor which accepts a touch operation to the screen in association with displaying the second image; and a processor which performs a process different depending on a manner of the touch operation accepted by the acceptor.

According to the present invention, a computer program embodied in a tangible medium, which is executed by a processor of a display control apparatus provided with a first displayer which displays a first image on a screen and a second displayer which displays a second image on the screen, the program comprises: a determining step of repeatedly determining whether or not an object exists near the screen; a displaying step of displaying the second image when it is determined by the determining step that the object exists near the screen; a hiding step of hiding the second image when it is determined by the determining step that the object does not exist near the screen; an accepting step of accepting a touch operation to the screen in association with displaying the second image; and a processing step of performing a process different depending on a manner of the touch operation accepted by the accepting step.

According to the present invention, A display control method executed by a display control apparatus provided with a first displayer which displays a first image on a screen and a second displayer which displays a second image on the screen, comprises: a determining step of repeatedly determining whether or not an object exists near the screen; a displaying step of displaying the second image when it is determined by the determining step that the object exists near the screen; a hiding step of hiding the second image when it is determined by the determining step that the object does not exist near the screen; an accepting step of accepting a touch operation to the screen in association with displaying the second image; and a processing step of performing a process different depending on a manner of the touch operation accepted by the accepting step.

A display control apparatus according to the present invention, comprises: a first displayer which displays an optical image of a subject on a screen; a second displayer which displays information related to photographing or reproducing on the screen; a determiner which repeatedly determines whether or not an object exists near the screen; and a processor which displays the information related to photographing or reproducing when it is determined by the determiner that the object exists near the screen, and hides the information related to photographing or reproducing when it is determined by the determiner that the object does not exist near the screen.

The above described features and advantages of the present invention will become more apparent from the following detailed description of the embodiment when taken in conjunction with the accompanying drawings.

### BRIEF DESCRIPTION OF THE DRAWINGS

FIG. 1(A) is a block diagram showing a basic configuration of one embodiment of the present invention;

FIG. 1(B) is a block diagram showing a basic configuration of another embodiment of the present invention;

FIG. 2 is a block diagram showing a configuration of one embodiment of the present invention;

FIG. 3 is an illustrative view showing one example of an allocation state of an evaluation area in an imaging surface;

FIG. 4 is an illustrative view showing one portion of behavior of the embodiment in FIG. 2;

FIG. 5 is an illustrative view showing one example of a positional relationship between an LCD monitor applied to the embodiment in FIG. 2 and a finger of an operator;

FIG. 6(A) is an illustrative view showing one example of a display state of the LCD monitor applied to the embodiment in FIG. 2;

FIG. 6(B) is an illustrative view showing another example of the display state of the LCD monitor applied to the embodiment in FIG. 2;

FIG. 7 is a flowchart showing one portion of behavior of a CPU applied to the embodiment in FIG. 2;

FIG. 8 is a flowchart showing another portion of behavior of the CPU applied to the embodiment in FIG. 2;

FIG. 9 is a flowchart showing still another portion of behavior of the CPU applied to the embodiment in FIG. 2;

FIG. 10 is a flowchart showing yet another portion of behavior of the CPU applied to the embodiment in FIG. 2; and

FIG. 11 is a block diagram showing a configuration of another embodiment of the present invention.

### DETAILED DESCRIPTION OF THE PREFERRED EMBODIMENTS

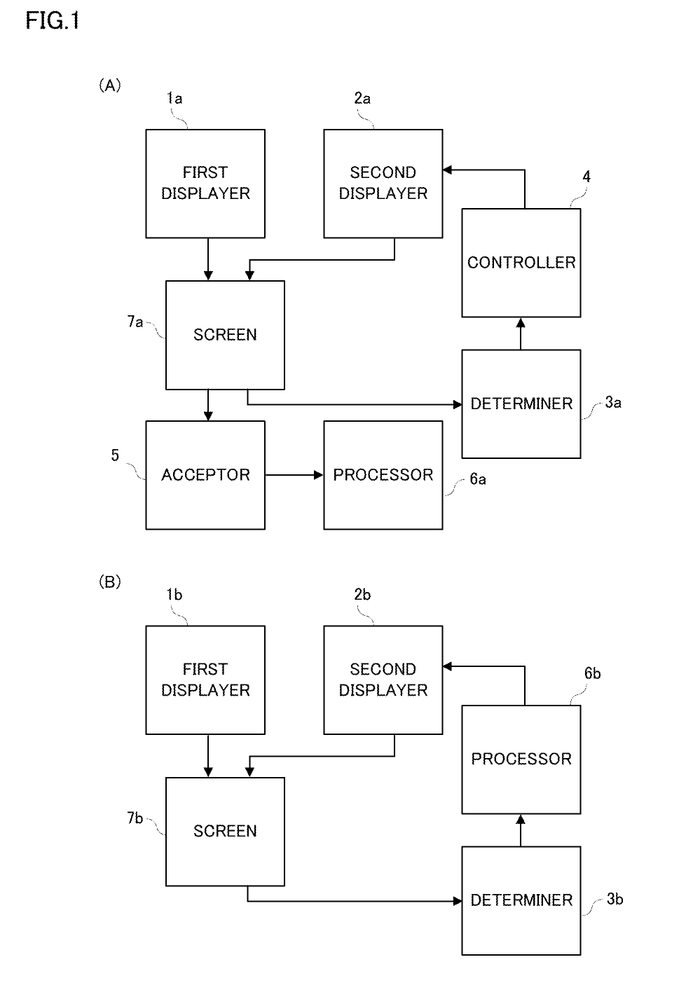

With reference to FIG. 1(A), a display control apparatus according to one embodiment of the present invention is basically configured as follows: A first displayer 1a displays a first image on a screen 7a. A second displayer 2a displays a second image on the screen 7a. A determiner 3a repeatedly determines whether or not an object exists near the screen 7a. A controller 4 displays the second image when it is determined by the determiner 3a that the object exists near the screen 7a, and hides the second image when it is determined by the determiner 3a that the object does not exist near the screen 7a. An acceptor 5 accepts a touch operation to the screen 7a in association with displaying the second image. A processor 6a performs a process different depending on a manner of the touch operation accepted by the acceptor 5.

During the object is away from the screen 7a, out of the first image and the second image, only the first image is displayed on the screen 7a. Thereby, a visibility of the first image is improved. When the object comes close to the screen 7a, both of the first image and the second image are displayed on the screen 7a, and it becomes possible to perform the touch operation referring to the second image. Thereby, operability is improved. That is, by changing a display manner of the screen 7a corresponding to a distance relationship between the screen 7a and the object, it becomes possible to support the improvement of the visibility of the first image and the improvement of the operability at the same time, and thereby; a behavior performance is improved.

With reference to FIG. 1(B), a display control apparatus according to one embodiment of the present invention is basically configured as follows: A first displayer 1b displays an optical image of a subject on a screen 7b. A second displayer 2b displays information related to photographing or reproducing on the screen 7b. A determiner 3b repeatedly determines whether or not an object exists near the screen 7b. A processor 6b displays the information related to photographing or reproducing when it is determined by the determiner 3b that the object exists near the screen 7b, and hides the information related to photographing or reproducing when it is determined by the determiner 3b that the object does not exist near the screen 7b.

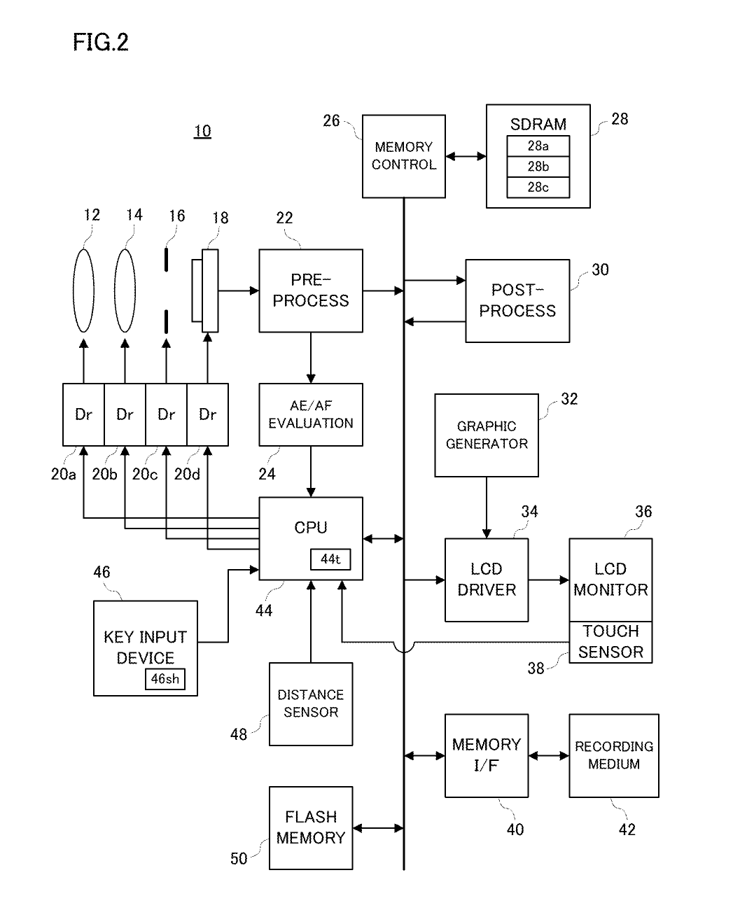

With reference to FIG. 2, a digital camera 10 according to one embodiment includes a zoom lens 12, a focus lens 14 and an aperture unit 16 driven by drivers 20a, 20b and 20c respectively. An optical image of a scene that underwent these components enters, with irradiation, an imaging surface of an imager 18.

When a power source is applied, in order to execute a moving-image taking process, a CPU 44 applies a corresponding command to a driver 20d. In response to a vertical synchronization signal Vsync periodically generated, the driver 20d exposes the imaging surface and reads out electric charges produced thereby from the imaging surface in a raster scanning manner. As a result, raw image data representing the scene is repeatedly outputted from an image sensor 18.

A pre-processing circuit 22 performs processes, such as digital clamp, pixel defect correction, gain control and etc., on the raw image data outputted from the image sensor 18. The raw image data on which these pre-processes are performed is written into a raw image area 28a of an SDRAM 28 through a memory control circuit 26.

A post-processing circuit 30 repeatedly reads out the raw image data by accessing the raw image area 28a through the memory control circuit 26. The read-out raw image data is subjected to processes, such as a color separation, a white balance adjustment and a YUV conversion, and thereby, YUV-formatted image data is created. The created image data is written into a WV image area 28b of the SDRAM 28 through the memory control circuit 26.

An LCD driver 34 repeatedly reads out the image data accommodated in the YUV image area 28b, and drives an LCD monitor 36 based on the read-out image data. As a result, a real-time moving image (a live view image) representing the scene is displayed on a monitor screen.

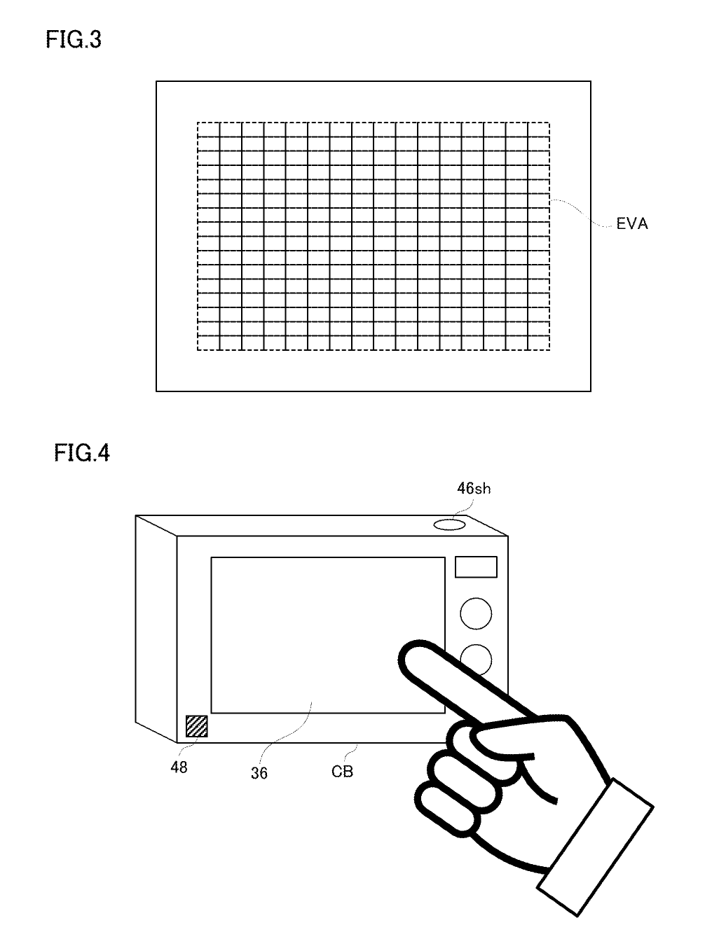

With reference to FIG. 3, an evaluation area EVA is allocated to the imaging surface. The evaluation area EVA is divided into 16 portions in each of a horizontal direction and a vertical direction; therefore, 256 divided areas are placed in a matrix on the imaging surface. The pre-processing circuit 22 simply converts a part of the raw image data belonging to the evaluation area EVA into Y data so as to apply the converted Y data to an AE/AF evaluating circuit 24.

The AE/AF evaluating circuit 24 integrates the applied Y data for each divided area so as to create a total of 256 integrated values as luminance evaluation values. Moreover, the AE/AF evaluating circuit 24 integrates a high-frequency component of the applied Y data for each divided area so as to create a total of 256 integrated values as AF evaluation values. These integrating processes are repeatedly executed at every time the vertical synchronization signal Vsync is generated. As a result, 256 luminance evaluation values and 256 AF evaluation values are outputted from the AE/AF evaluating circuit 24 in response to the vertical synchronization signal Vsync.

When a shutter button 46sh arranged in a key input device 46 is in a non-operated state, the CPU 44 executes a simple AE process with reference to the luminance evaluation values outputted from the AE/AF evaluating circuit 24 so as to calculate an appropriate EV value. An aperture amount and an exposure time period that define the calculated appropriate EV value are set to the drivers 20c and 20d, and thereby, a brightness of the live view image is adjusted approximately.

When the shutter button 46sh is operated, the CPU 44 executes a strict AE process referring to the luminance evaluation values so as to calculate an optimal EV value. Also an aperture amount and an exposure time period that define the calculated optimal EV value are set to the drivers 20c and 20d, and thereby, a brightness of the live view image is adjusted to an optimal value. Moreover, the CPU 44 executes an AF process with reference to the AF evaluation values outputted from the AE/AF evaluating circuit 24. The focus lens 12 is set to a focal point discovered by the AF process, and thereby, a sharpness of the live view image is improved.

Upon completion of the AF process, the CPU 44 commands the memory control circuit 26 to execute a still-image taking process and commands a memory OF 40 to execute a recording process. The memory control circuit 26 evacuates the latest one frame of the image data accommodated in the YUV image area 28b to a still-image area 28c. Moreover, the memory I/F 40 reads out the image data evacuated to the still-image area 28c through the memory control circuit 26 so as to record the read-out image data in a file format on a recording medium 42.

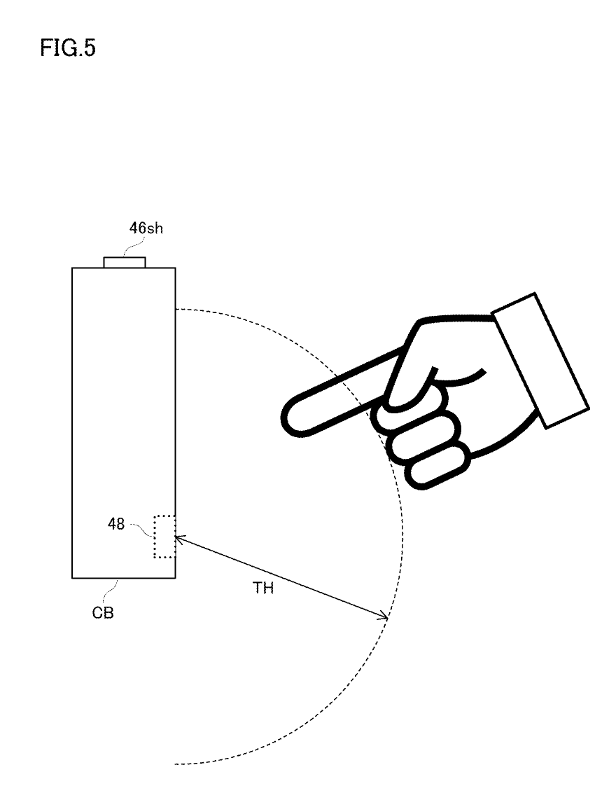

With reference to FIG. 4, the LCD monitor 36 is installed at an approximately center of a rear surface of a camera housing CB. Moreover, a distance sensor 48 is installed at a lower left of the rear surface of the camera housing CB. An output of the distance sensor 48 indicates an L level when the object (a finger of the operator, for example) does not exist in a detection range while indicates an H level when the object exists in the detection range. Here, the detection range is equivalent to a range in which a distance from the distance sensor 48 falls below a threshold value TH (see FIG. 5). Thus, the output of the distance sensor 48 rises when the finger of the operator has come close to the LCD monitor 36 while falls when the finger of the operator has moved away from the LCD monitor 36.

In response to a rise of the output of the distance sensor 48, the CPU 44 commands or requests a graphic generator 32 to display an icon ICN1 for a zoom operation. The graphic generator 32 creates corresponding graphic data so as to apply the created graphic data to the LCD driver 34.

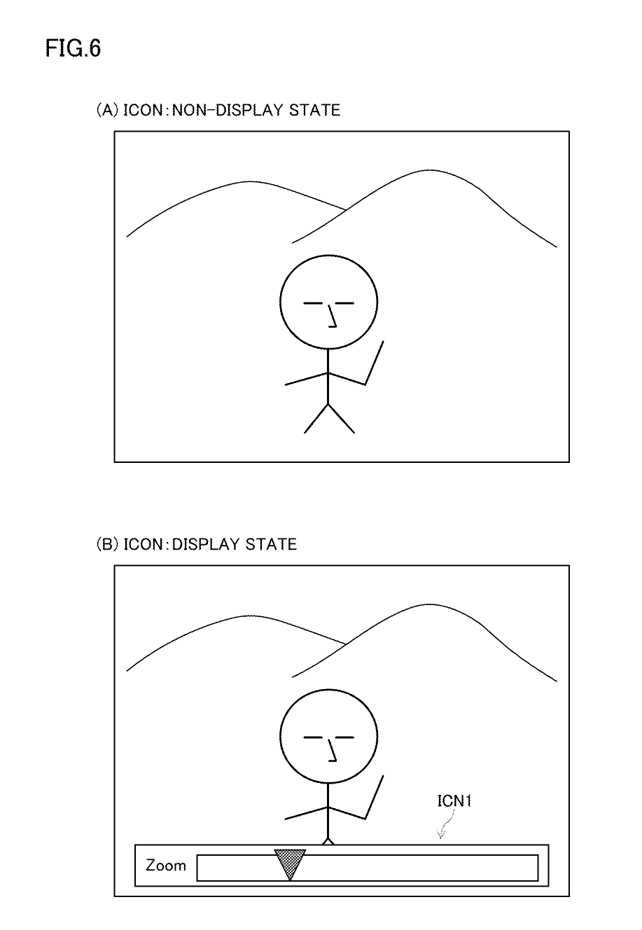

The LCD driver 34 mixes the image data read out from the YUV image area 28b with the graphic data applied from the graphic generator 32, and drives the LCD monitor based on mixed image data generated thereby. As a result, the icon ICN1 is displayed on the live view image in an OSD manner. If the output of the distance sensor 48 rises when the live view image is being displayed as shown in FIG. 6(A), the icon ICN1 is multiplexed onto the live view image as shown in FIG. 6(B).

If the displayed icon ICN1 is touched, detected data in which a touch position is described is applied from a touch sensor 38 to the CPU 44. The CPU 44 specifies the manner of the touch operation based on the applied detected data so as to apply a corresponding command to the driver 20a. As a result, the zoom lens is moved in an optical-axis direction, and a zoom magnification of the live view image is changed.

When the finger of the operator deviates from the detection range, the output of the distance sensor 48 falls. The CPU 44 executes resetting and starting a timer 44t in response thereto, and commands or requests the graphic generator 32 to hide (suspend to display) the icon ICN when time-out is occurred in the timer 44t (when a timer value reaches two seconds, for example). The graphic generator 32 stops to output the graphic data, and as a result, a display of the LCD monitor 36 returns from FIG. 6(B) to FIG. 6(A).

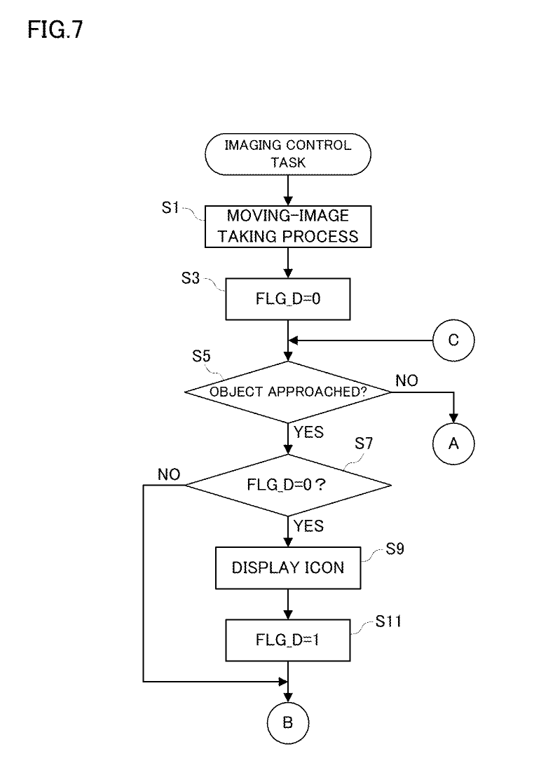

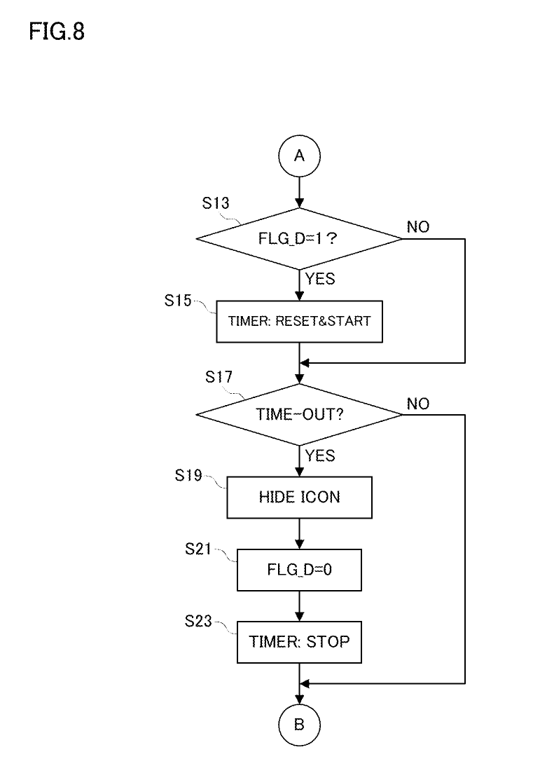

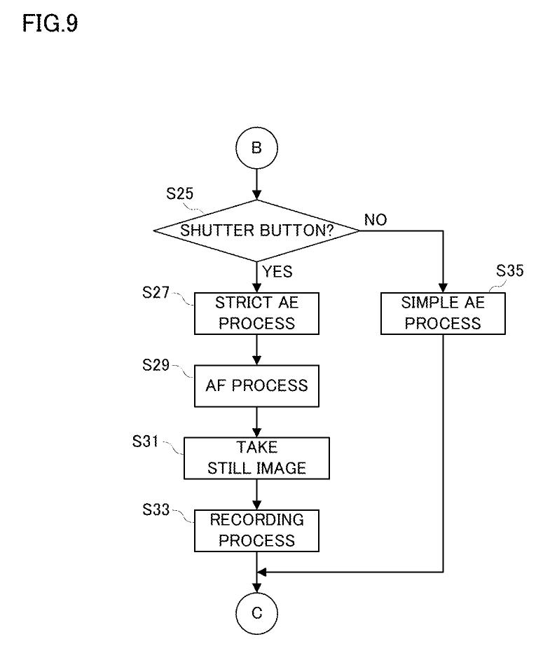

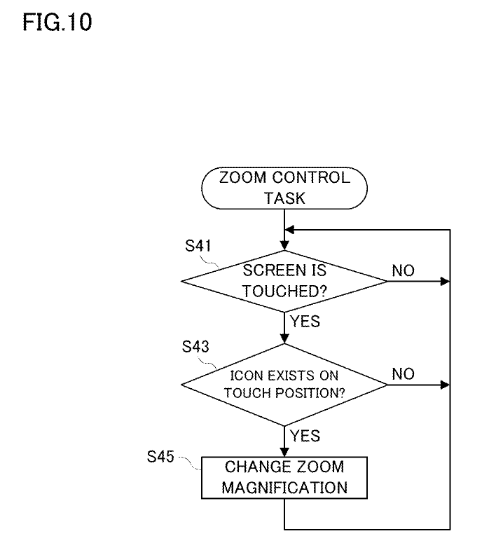

The CPU 44 executes, under a multi task operating system, a plurality of tasks including an imaging control task shown in FIG. 7 to FIG. 9 and a zoom control task shown in FIG. 10, in a parallel manner. It is noted that, control programs corresponding to these tasks are stored in a flash memory 50.

With reference to FIG. 7, in a step S1, the moving-image taking process is executed. Thereby, the live view image is displayed on the LCD monitor 36. In a step S3, a flag FLG_D is set to “0” in order to declare that the icon ICN1 is hidden. In a step S5, it is determined whether or not the object such as the finger of the operator exists near the LCD monitor 36 (=detection range), based on the output of the distance sensor 48. When a determined result is YES, the process advances to a step S7 while when the determined result is NO, the process advances to a step S13.

In the step S7, it is determined whether or not the flag FLG_D is “0”, and when a determined result is NO, the process directly advances to a step S25 while when the determined result is YES, the process advances to the step S25 via processes in steps S9 to S11. In the step S9, the corresponding command or request is applied to the graphic generator 32 in order to display the icon ICN1. In the step S11, in order to declare that the icon ICN is displayed, the flag FLG_D is set to “1”.

In the step S13, it is determined whether or not the flag FLG_D indicates “1”, and when a determined result is NO, the process directly advances to a step S17 while when the determined result is YES, the process advances to the step S17 after resetting and starting the timer 44t is executed in a step S15. In the step S17, it is determined whether or not the time-out is occurred in the timer 44t, and when a determined result is NO, the process directly advances to the step S25 while when the determined result is YES, the process advances to the step S25 via processes in steps S19 to S23.

In the step S19, the graphic generator 32 is commanded or requested to hide (suspend to display) the icon ICN1. The graphic generator 32 stops to output the corresponding graphic data, and thereby, the icon ICN1 is hidden. In the step S21, the flag FLG_D is set to “0”, and in the step S23, the timer 1 it is stopped.

In the step S25, it is determined whether or not the shutter button 46sh is operated, and when a determined result is NO, the process advances to a step S35 while when YES is determined, the process advances to a step S27. In the step S35, the simple AE process is executed based on the luminance evaluation values outputted from the AE/AF evaluating circuit 24. Thereby, the brightness of the live view image is adjusted approximately. Upon completion of the process in the step S35, the process returns to the step S5.

In the step S27, the strict AE process is executed based on the luminance evaluation values outputted from the AE/AF evaluating circuit 24. Thereby, the brightness of the live view image is adjusted to the optimal value. In a step S29, the AF process is executed based on the AF evaluation values outputted from the AE/AF evaluating circuit 24. Thereby, the sharpness of the live view image is improved.

In a step S31, the still-image taking process is executed, and in a step S33, the recording process is executed. The image data representing the scene at a time point at which the shutter button 46sh is operated is evacuated to the still-image area 28c by the still-image taking process, and is recorded on the recording medium 42 by the recording process. Upon completion of the process in the step S33, the process returns to the step S5.

With reference to FIG. 10, in a step S41, it is determined whether or not the screen of the LCD monitor 36 is touched, and in a step S43, it is determined whether or not the icon ICN1 exists on the touch position. Both of the determining processes are performed based on the output of the touch sensor 38. When YES is determined in both of the steps S41 and S43, the process advances to a step S45. In the step S45, the zoom lens 12 is moved in order to change the zoom magnification to a direction according to the touch operation. Upon completion of the process in the step S45, the process returns to the step S41.

As can be seen from the above-described explanation, the live view image is displayed on the LCD monitor 36 by the LCD driver 34, via the processes of the pre-processing circuit 22 and the post-processing circuit 30. Moreover, the icon ICN1 is displayed on LCD monitor 36 by the graphic generator 32 and the LCD driver 34. The CPU 44 repeatedly determines whether or not the finger of the operator exists near the screen of the LCD monitor 36 in association with the process of displaying the live view image (S5), and displays the icon ICN1 based on a positive determined result (S9) while stops to display the icon ICN1 based on a negative determined result (S17, S19). Moreover, the CPU 44 accepts the touch operation to the displayed icon ICN1 (S41 to S43), and changes the zoom magnification in a manner according to the touch operation (S45).

Thus, during the finger is away from the screen, out of the live view image and the icon ICN1, only the live view image is displayed on the screen. Thereby, the visibility of the live view image is improved. When the finger comes close to the screen, both of the live view image and the icon ICN1 are displayed on the screen, and it becomes possible to perform the touch operation referring to the icon ICN1. Thereby the operability is improved. That is, by changing a display manner of the screen depending on a distance relationship between the screen and the finger, it becomes possible to support the improvement of the visibility of the live view image and the improvement of the operability at the same time, and thereby, the behavior performance is improved.

It is noted that, in this embodiment, an approach of the finger of the operator is sensed by the distance sensor 48. However, the approach of the finger of the operator may be sensed by an image sensor which senses an image representing the finger of the operator or a temperature sensor which senses an area having a shape equivalent to the finger and a temperature equivalent to a body temperature of a person.

Moreover, in this embodiment, it is assumed that the icon ICN1 for the zoom operation is multiplexed onto the live view image, however, an icon for adjusting another imaging condition may be multiplexed. Furthermore, in this embodiment, it is assumed that the icon is displayed in an overlapped manner under the imaging mode, however, an icon for a reproducing control operation may be multiplexed onto a still image or a moving image reproduced under a reproducing mode.

Moreover, in this embodiment, the icon is assumed as a target of touch operation, however, a touch-keyboard image for inputting a desired text may be assumed as the target of touch operation.

Moreover, in this embodiment, the digital camera is assumed, however, the present invention may be applied to all mobile electronic devices having the screen displaying the image.

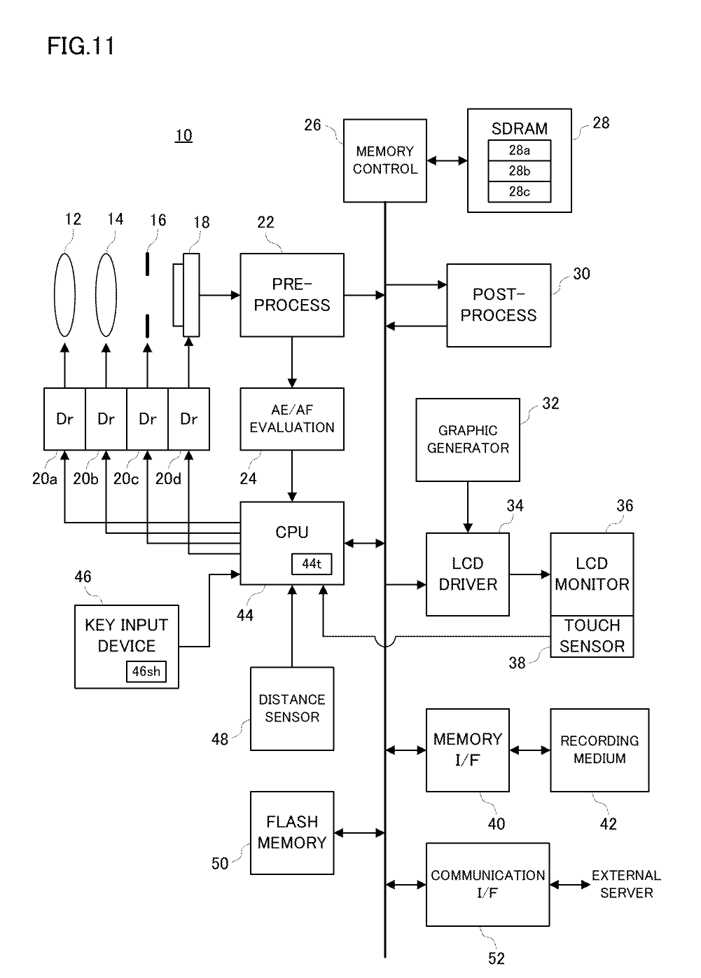

Furthermore, in this embodiment, the control programs equivalent to the multi task operating system and the plurality of tasks executed thereby are previously stored in the flash memory 50. However, a communication IP 52 may be arranged in the digital camera 10 as shown in FIG. 11 so as to initially prepare a part of the control programs in the flash memory 50 as an internal control program while acquire another part of the control programs from the external server as an external control program. In this case, the above-described procedures are realized in cooperation with the internal control program and the external control program.

Moreover, in this embodiment, the processes executed by the CPU 44 are divided into a plurality of tasks including the imaging control task shown in FIG. 7 to FIG. 9 and the zoom control task shown in FIG. 10. However, each of tasks may be further divided into a plurality of small tasks, and furthermore, a part of the divided plurality of small tasks may be integrated into another task. Moreover, when each of tasks is divided into the plurality of small tasks, the whole task or a part of the task may be acquired from the external server.

Although the present invention has been described and illustrated in detail, it is clearly understood that the same is by way of illustration and example only and is not to be taken by way of limitation, the spirit and scope of the present invention being limited only by the tenors of the appended claims.

What is claimed is:

1. A display control apparatus, comprising:
a first displayer which displays a first image on a screen;
a second displayer which displays a second image on said screen;
a determiner which repeatedly determines whether or not an object exists near said screen;
a controller which displays the second image when it is determined by said determiner that the object exists near said screen, and hides the second image when it is determined by said determiner that the object does not exist near said screen;
an acceptor which accepts a touch operation to said screen in association with displaying the second image; and
a processor which performs a process different depending on a manner of the touch operation accepted by said acceptor.

2. A display control apparatus according to claim 1, further comprising an imager which captures a scene, wherein the first image displayed by said first displayer is equivalent to an image representing the scene captured by said imager.

3. A display control apparatus according to claim 2, wherein the second image displayed by said second displayer is equivalent to a character image for an imaging setting.

4. A display control apparatus according to claim 1, further comprising a measurer which measures a period during which the negative determined result of said determiner continues, wherein the second image is hid at a time point at which the period measured by said measurer reaches a threshold value.

5. A computer program embodied in a tangible medium, which is executed by a processor of a display control apparatus provided with a first displayer which displays a first image on a screen and a second displayer which displays a second image on said screen, said program comprising:
a determining step of repeatedly determining whether or not an object exists near said screen;
a displaying step of displaying the second image when it is determined by said determining step that the object exists near said screen;
a hiding step of hiding the second image when it is determined by said determining step that the object does not exist near said screen;
an accepting step of accepting a touch operation to said screen in association with displaying the second image; and
a processing step of performing a process different depending on a manner of the touch operation accepted by said accepting step.

6. A display control method executed by a display control apparatus provided with a first displayer which displays a first image on a screen and a second displayer which displays a second image on said screen, comprising:
a determining step of repeatedly determining whether or not an object exists near said screen;
a displaying step of displaying the second image when it is determined by said determining step that the object exists near said screen;
a hiding step of hiding the second image when it is determined by said determining step that the object does not exist near said screen;
an accepting step of accepting a touch operation to said screen in association with displaying the second image; and
a processing step of performing a process different depending on a manner of the touch operation accepted by said accepting step.

7. A display control apparatus, comprising:
a first displayer which displays an optical image of a subject on a screen;
a second displayer which displays information related to photographing or reproducing on said screen;
a determiner which repeatedly determines whether or not an object exists near said screen; and
a processor which displays the information related to photographing or reproducing when it is determined by said determiner that the object exists near said screen, and hides the information related to photographing or reproducing when it is determined by said determiner that the object does not exist near said screen.

8. A display control apparatus according to claim 7, wherein information displayed by said second displayer is displayed in a manner to be overlapped on the optical image displayed by said first displayer.
